(19) United States
(12) Patent Application Publication
(10) Pub. No.: US 2024/0239963 A1
(43) Pub. Date: Jul. 18, 2024

(54) REACTION PRODUCT, METHOD OF MAKING THE SAME, AND CURABLE COMPOSITIONS INCLUDING THE SAME

(71) Applicant: 3M INNOVATIVE PROPERTIES COMPANY, Saint Paul, MN (US)

(72) Inventors: Claire Hartmann-Thompson, Lake Elmo, MN (US); Erik M. Townsend, South St. Paul, MN (US); Binhong Lin, Woodbury, MN (US); Phillip D. Hustad, St. Paul, MN (US)

(21) Appl. No.: 18/285,832

(22) PCT Filed: Mar. 4, 2022
(86) PCT No.: PCT/IB2022/051947

§ 371 Date: Oct. 5, 2023

Related U.S. Application Data
(60) Provisional application No. 63/174,837, filed on Apr. 14, 2021.

(51) Int. Cl. C08G 77/60

(52) U.S. Cl. CPC C08G 77/60

(57) ABSTRACT

A reaction product of components comprising: an alicyclic hydrocarbon containing at least one 5- or 6-membered ring and having at least two carbon-carbon multiple bonds; and a first organosilane represented by the formula. Each R independently represents an aliphatic hydrocarbyl group having from 1 to 8 carbon atoms. Z represents —(CH₂)_{y}— or —(OSiR₂)_{y}— and y is an integer from 1 to 18. A method of making the reaction product and curable compositions containing the reaction product are also disclosed.

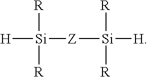

### TECHNICAL FIELD

The present disclosure broadly relates to organic reaction products containing silicon, methods of making them, and curable compositions including them.

### BACKGROUND

Fifth-generation wireless (5G) is the latest iteration of cellular technology, engineered to greatly increase the speed and responsiveness of wireless networks. With 5G, data transmitted over wireless broadband connections can travel at multigigabit speeds, with potential peak speeds as high as 20 gigabits per second (Gbit/s) by some estimates. The increased speed is achieved partly by using higher frequency radio waves than current cellular networks. However, higher frequency radio waves have a shorter range than the frequencies used by previous networks. So to ensure wide service, 5G networks operate on up to three frequency bands, low, medium, and high. A 5G network will be composed of networks of up to 3 different types of cell, each requiring different antennas, each type giving a different tradeoff of download speed vs. distance and service area. 5G cellphones and wireless devices will connect to the network through the highest speed antenna within range at their location.

Low-band 5G uses a similar frequency range as current 4G cellphones, 600-700 MHz giving download speeds a little higher than 4G: 30-250 megabits per second (Mbit/s). Low-band cell towers will have a similar range and coverage area to current 4G towers. Mid-band 5G uses microwaves of 2.5-3.7 GHz, currently allowing speeds of 100-900 Mbit/s, with each cell tower providing service up to several miles radius. High-band 5G uses frequencies of 25-39 GHZ, near the bottom of the millimeter wave band, to achieve download speeds of 1-3 gigabits per second (Gbit/s), comparable to cable internet.

Many materials used in the telecommunication industry today do not perform well at 5G frequencies. Thus, the higher frequencies of 5G necessitate the identification and development of materials that can function at those frequencies and not interfere with proper functioning of electronic devices communicating at high-band wavelengths.

### SUMMARY

The present disclosure provides new and useful compositions having low dielectric constant and/or low dielectric loss characteristics suitable for use in 5G enabled wireless telecommunication devices, especially in the context of gap fillers and Organic Light Emitting Diode (OLED) encapsulant inks.

In one aspect, the present disclosure provides a reaction product of components comprising:
an alicyclic hydrocarbon containing at least one 5- or 6-membered ring and having at least two carbon-carbon multiple bonds; and
a first organosilane represented by the formula

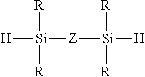

wherein each R independently represents an aliphatic hydrocarbyl group having from 1 to 8 carbon atoms, and Z represents —(CH₂)_{y}— or —(OSiR₂)_{y}—, wherein y is an integer from 1 to 18.

Reaction products according to the present disclosure can be made by various methods. Accordingly, in a second aspect, the present disclosure provides a two-part curable composition comprising:
a Part A comprising:
   a reaction product according to the present disclosure, and
   a hydrosilylation catalyst; and
a Part B comprising a second organosilane represented by the formula

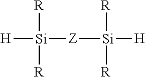

wherein each R independently represents an aliphatic hydrocarbyl group having from 1 to 8 carbon atoms, and Z represents —(CH₂)_{y}— or —(OSiR₂)_{y}—, wherein y is an integer from 1 to 18.

And, in yet another aspect, the present disclosure provides a curable composition comprising a reaction product according to the present disclosure and a free-radical initiator.

The reaction product can be made by a hydrosilylation reaction. Accordingly, in yet another aspect, the present disclosure provides a method of making a reaction product, the method comprising combining components comprising:
a) an alicyclic hydrocarbon containing at least one 5- or 6-membered ring and having at least two carbon-carbon multiple bonds;
b) a first organosilane represented by the formula

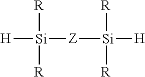

wherein each R independently represents an aliphatic hydrocarbyl group having from 1 to 8 carbon atoms, and Z represents —(CH₂)_{y}— or —(OSiR₂)_{y}—, wherein y is an integer from 1 to 18; and
c) a hydrosilylation catalyst.

As used herein:
the term “alicyclic” means containing one or more all-carbon rings which may be either saturated or unsaturated, but do not have aromatic character, and which may have one or more aliphatic side chains attached; and
the terms “hydrosilylation” and hydrosilation” are equivalent.

All numerical ranges used herein are inclusive of their endpoints unless otherwise specified. Features and advantages of the present disclosure will be further understood upon consideration of the detailed description as well as the appended claims.

### DETAILED DESCRIPTION

Reaction products according to the present disclosure can be reaction products of components comprising: an alicyclic hydrocarbon containing at least one 5- or 6-membered ring and having at least two carbon-carbon multiple bonds, and an organosilane represented by the formula

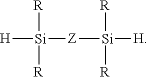

Each R independently represents an aliphatic hydrocarbyl group having from 1 to 8 carbon atoms. Exemplary R groups include methyl, ethyl, propyl, isopropyl, butyl, isobutyl, sec-butyl, pentyl, isopentyl, cyclopentyl, hexyl, cyclohexyl, heptyl, octyl, and isooctyl. In some preferred embodiments, each R independently represents an alkyl group having from 1 to 4 carbon atoms (e.g., methyl ethyl, n-propyl, isopropyl, n-butyl, sec-butyl, isobutyl, or tert-butyl), more preferably methyl or ethyl.

Z represents —(CH₂)_{y}— or —(OSiR₂)_{y}—, where R is as previously defined and y is an integer from 1 to 18. Exemplary y values are 1, 2, 3, 4, 5, 6, 7, 8, 9, 10, 11, 12, 13, 14, 15, 16, 7, and 18. In some embodiments, y is an integer from 1 to 8, preferably 1 to 6, and more preferably 1 to 4.

Organosilanes useful in practice of the present disclosure can be obtained from commercial sources such as, for example, Gelest, Inc., Morrisville, Pennsylvania and/or MilliporeSigma, Saint Louis, Missouri, or be synthesized according to known methods. For example, hydrosilanes may be synthesized by hydride reduction of corresponding chloro- or alkoxysilanes using reactive metal hydrides such as lithium aluminum hydride (LiAlH₄), sodium borohydride, and diisobutylaluminum hydride (DIBAL-H).

The alicyclic hydrocarbon contains at least one 5- or 6-membered ring and has at least two carbon-carbon multiple bonds. In some embodiments, at least one of the at least two carbon-carbon multiple bonds is contained within the at least one 5- or 6-membered ring. In some embodiments, the 5- or 6-membered ring is bonded to from 2 to 4 monovalent groups having the formula —(CH₂)ₓCH═CH₂. Each x is independently 0 or 1.

Exemplary useful alicyclic hydrocarbons include divinylcyclohexane, diallylcyclohexane, trivinylcyclohexane, triallylcyclohexane, diallylcyclopentane, tetravinylcyclohexane, tetraallylcyclohexane, cyclopentadiene, dicyclopentadiene, vinylnorbornene, allylonorbornene, vinylcyclohexene, allyl cyclohexene, divinylcyclopentene, butenylcyclohexene, octenylcyclohexene, diallylcyclopentene, 5-ethylidenenorbornene, 5-propylidenenorbornene, 5-hexylidenenorbornene, 5-decylidenenorbornene, 5-methylene-6-methylnorbornene, 5-methylene-6-hexylnorbornene, 5-cyclohexylidenenorbornene, 5-cyclooctylidenenorbornene, 7-isopropylidenenorbornene, 5-methyl-7-isopropylidenenorbornene, methyl-6-methylenenorbornene, 7-ethylidenenorbornene, and 5-methyl-7-propylidenenorbornene, and combinations thereof.

Useful alicyclic hydrocarbons may be obtained from commercially sources such as, for example, MilliporeSigma and/or synthesized according to known methods.

The reaction product may be a linear polymer, or a branched polymer. In some preferred embodiments, the reaction product comprises a hyperbranched polymer, preferably having a plurality of vinyl groups. Hyperbranched polymers (e.g., a reaction product) are highly branched three-dimensional (3D) structures which have a multiplicity of reactive chain-ends. Generally, they do not constitute a 3-dimensional crosslinked network. Hyperbranched polymers can be made by careful attention to stoichiometry during manufacture according to methods well known in the chemical arts.

The foregoing reaction products according to the present disclosure can be made by hydrosilylation chemistry, for example, by combining components comprising:
a) an alicyclic hydrocarbon containing at least one 5- or 6-membered ring and having at least two carbon-carbon multiple bonds as previously described;
b) an organosilane represented by the formula

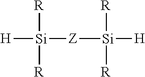

as previously described; and
c) a hydrosilylation catalyst.

Hydrosilylation, also called catalytic hydrosilylation, describes the addition of Si—H bonds across unsaturated bonds. The hydrosilylation reaction is typically catalyzed by a platinum catalyst, and generally heat is applied to effect the reaction. In this reaction, the Si—H adds across the double bond to form new C—H and Si—C bonds. This process in described, for example, in PCT Publication No. WO 2000/068336 (Ko et al.), and PCT Publication Nos. WO 2004/111151 (Nakamura) and WO 2006/003853 (Nakamura).

Useful hydrosilylation catalysts may include thermal catalysts (which may be activated at or above room temperature) and/or photocatalysts. Of these, photocatalysts may be preferred due to prolonged storage stability and ease of handling. Exemplary thermal catalysts include platinum complexes such as H₂PtCl₆ (Speier's catalyst); organometallic platinum complexes such as, for example, a coordination complex of platinum and a divinyldisiloxane (Karstedt's catalyst); and chloridotris(triphenylphosphine)rhodium(I) (Wilkinson's catalyst),

Useful platinum photocatalysts are disclosed, for example, in U.S. Pat. No. 7,192,795 (Boardman et al.) and references cited therein. Certain preferred platinum photocatalysts are selected from the group consisting of Pt(II) β-diketonate complexes (such as those disclosed in U.S. Pat. No. 5,145,886 (Oxman et al.)). (η5-cyclopentadienyl)tri(σ-aliphatic)platinum complexes (such as those disclosed in U.S. Pat. No. 4,916,169 (Boardman et al.) and U.S. Pat. No. 4,510,094 (Drahnak)), and C7-20-aromatic substituted (η5-cyclopentadienyl)tri(σ-aliphatic)platinum complexes (such as those disclosed in U.S. Pat. No. 6,150,546 (Butts)). Hydrosilylation photocatalysts are activated by exposure to actinic radiation, typically ultraviolet light, for example, according to known methods.

The amount of hydrosilylation catalyst may be any effective amount. In some embodiments, the amount of hydrosilylation catalyst is in an amount of from about 0.5 to about 30 parts by weight of platinum per one million parts by weight of the total composition in which it is present, although greater and lesser amounts may also be used.

Hydrosilylation reaction products having pendant vinyl groups according to the present disclosure can be used in curable compositions when combined with a free-radical initiator. Useful free-radical initiators may include thermal free-radical initiators such as, for example, organic peroxides (e.g., methyl ethyl ketone peroxide, dicumyl peroxide, or benzoyl peroxide) and azo compounds (e.g., azobisisobutyronitrile), inorganic peroxide (e.g., sodium persulfate), and/or photoinitiators such as, for example, Type 1 (e.g., 2,2-dimethoxy-1,2-diphenyl-ethan-1-one, 1-hydroxycyclohexylphenyl-ketone and 2-hydroxy-2-methyl-1-phenylpropanone) and Type II photoinitiators (e.g., benzophenone and isopropyl thioxanthone). Other suitable initiators will be known to those skilled in the art.

The amount of free-radical initiator is typically from 0.01 to 10 percent by weight, preferably 0.1 to 3 percent by weight, of the curable composition, although other amounts can be used. Combinations of free-radical initiators may be used. Curing can be effected by heating in the case of thermal free-radical initiators or by exposure to actinic radiation (e.g., ultraviolet and/or visible light) in the case of photoinitiators.

In another embodiment, a two-part curable composition comprises a Part A component containing a hydrosilylation reaction product according to the present disclosure and a hydrosilylation catalyst, for example as described hereinabove. A Part B component contains an organosilane represented by the formula

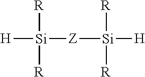

wherein R is as previously defined.

Curable and cured compositions according to the present disclosure are useful, for example, as encapsulants, gap fillers, sealants, inks (e.g., inks for encapsulation OLED electronic components), and/or adhesives for electronic components used in 5G compatible equipment, for example.

Curable compositions according to the present disclosure may include various additives such as, for example, thermally-conductive and/or electrically-conductive filler particles.

Exemplary electrically-insulative thermal fillers include boron nitride, aluminum nitride, silicon nitride, aluminum oxide (alumina), magnesium oxide, zinc oxide, silicon oxide, beryllium oxide, titanium oxide, copper oxide, cuprous oxide, magnesium hydroxide, aluminum hydroxide, silicon carbide, diamond, talc, mica, kaolin, bentonite, magnesite, pyrophyllite, titanium boride, calcium titanate, and combinations thereof. Boron nitride may have any structure, such as c-BN (cubic structure), w-BN (wurtzite structure), h-BN (hexagonal structure), r-BN (rhombohedral structure), or t-BN (turbostratic structure). Among these, from the perspectives of thermal conductivity and cost, aluminum oxide, aluminum hydroxide, zinc oxide, boron nitride, and aluminum nitride are generally preferred. Aluminum oxide and aluminum hydroxide are more preferred, and aluminum hydroxide is particularly preferred.

Exemplary electrically-conductive thermally conductive fillers include graphite, carbon black, carbon fibers (pitch-based, PAN-based), carbon nanotubes (CNT), graphene, carbon fibers, silver, copper, iron, nickel, aluminum, titanium, alloys thereof, stainless steel (SUS), zinc oxide to which different type of element is doped, ferrites, and combinations thereof. An insulating raw material, such as silica, may be coated with an electrically conductive thermally conductive raw material to make it electrically conductive, or an electrically conductive thermally conductive raw material may be coated with an insulating raw material, such as silica, to make it insulating, and these may be used as the thermally conductive raw materials.

Thermal filler particles preferably have a thermal conductivity of at least 1.0 W/m·K, at least 1.2 W/m·K, at least 1.5 W/m·K, at least 1.7 W/m·K, at least 2.0 W/m·K, at least 2.5 W/m·K, at least 10 W/m·K, at least 20 W/m·K, at least 40 W/m·K, or even at least 50 W/m·K, although lower and higher thermal conductivities may also be used.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, all other reagents were obtained, or are available from fine chemical vendors such as, for example, as MilliporeSigma Company, St. Louis, Missouri, or may be synthesized by known methods.

Table 1 (below) lists materials used in the examples and their sources.

TABLE 1

| DESIGNATION | DESCRIPTION | SOURCE |
|---|---|---|
| 1,1,4,4-Tetramethyl-1,4- | Obtained as product | Gelest, Inc., |
| disilabutane | code SIT7537.0 | Morrisville, |
| | | Pennsylvania |
| Tetravinylsilane, 95% | Obtained as product | Gelest, Inc. |
| | code SIT7897 | |
| Tetraallylsilane | Obtained as product | Gelest, Inc. |
| | code SIT7020 | |
| 1,7-Octadiene | | MilliporeSigma, |
| | | Saint Louis, |
| | | Missouri |
| 1,2,4-Trivinylcyclohexane | Obtained as product | TCI America, |
| | number T0899 | Portland, Oregon |
| 5-vinylbicyclo[2.2.1]hept- | Obtained as product | TCI America |
| 2-ene | number V0062 | |
| (5-Vinyl-2-norbornene) | | |
| Tetramethyldisiloxane | Obtained as product | TCI America |
| | number T1437 | |
| Platinum | Obtained as product | Gelest, Inc. |
| divinyltetramethyldisiloxane | code SIP6830.3 | |
| complex | | |
| (3 wt. % in vinyl- | | |
| terminated PDMS) | | |
| Dicumyl peroxide, 98% | | MilliporeSigma |

### Test Methods

### Cylindrical Dielectric Resonator Measurements for Liquids at 2.45 Ghz

A TE_{01δ} mode cylindrical dielectric resonator was used to measure the complex permittivity of dielectrics at a frequency 2.45 GHz using the method described in J. Krupka, K. Derzakowski, M.D. Janezic, and J. Baker-Jarvis, “TE₀₁delta dielectric resonator technique for precise measurements of the complex permittivity of lossy liquids at frequencies below 1 GHz”, Conference on Precision Electromagnetic Measurements Digest, pp. 469-470, London, 27 Jun.-2 Jul. 2004.

### Characterization by Differential Scanning Calorimetry (DSC)

DSC samples were prepared for thermal analysis by weighing and loading the material into TA Instruments (New Castle, Delaware) aluminum DSC sample pans. The specimens were analyzed using the TA Instruments Discovery Differential Scanning calorimeter (DSC—SN DSC1-0091) utilizing a heat-cool-heat method in standard mode (−155° C. to about 50° C. at 10° C./minute.). After data collection, the thermal transitions were analyzed using the TA Universal Analysis program. The glass transition temperatures were evaluated using the step change in the standard heat flow (HF) curves. The midpoint (half height) temperature of the second heat transition is reported.

### Characterization by Thermal Gravimetric Analysis (TGA)

The samples were analyzed using the TA Instruments Discovery Thermogravimetric Analyzer in HiRes mode. Each sample was loaded into a high temperature platinum TGA pan. The sample was subjected to a heating profile ranging from room temperature (˜ 35° C.) to 800° C. in air atmosphere, with a linear heating rate of 20.0° C./minute.

### Comparative Example 1 (CE-A)

PREPARATION OF LINEAR POLYMER 1: 1,1,4,4-Tetramethyl-1,4-disilabutane (25 grams (g), 0.171 mole (mol)) was added dropwise to a solution of 1,7-octadiene (19.8 g, 0.179 mol, 5 mol % excess) and platinum divinyltetramethyldisiloxane complex (1 drop, 3 wt. % Pt in vinyl-terminated PDMS) in toluene (100 milliliters (mL)). After an initial exotherm, the reaction mixture was stirred at room temperature for 2 days, and toluene and excess monomer was removed in vacuo to give the product as a viscous liquid.

### Example 1 (EX-1)

PREPARATION OF LINEAR POLYMER 2: 1,1,4,4-Tetramethyl-1,4-disilabutane (4.87 g, 0.033 mol) was added dropwise to a solution of 5-vinylbicyclo[2.2.1]hept-2-ene (4.00 g, 0.033 mol) and platinum divinyltetramethyldisiloxane complex (1 drop, 3 wt. % Pt in vinyl-terminated PDMS) in toluene (20 mL). After an initial exotherm, the reaction mixture was stirred at 60° C. for 12 hours. Further vinylbicyclo[2.2.1]hept-2-ene (0.05 g) was added and the mixture stirred a further 12 hours at 60° C. Toluene and excess monomer was removed in vacuo to give the product as a viscous liquid.

### Comparative Example B (CE-B)

PREPARATION OF HYPERBRANCHED POLYMER 3: 1,1,4,4-Tetramethyl-1,4-disilabutane (8.81 g, 0.0602 mol) was added dropwise to a solution of tetraallylsilane (17.9 g, 0.093 mol, 3.1 molar excess of allyl) and platinum divinyltetramethyldisiloxane complex (1 drop, 3 wt. % Pt in vinyl-terminated PDMS) in toluene (80 mL). After an initial exotherm, the reaction mixture was stirred at room temperature for 3 days, and toluene was removed in vacuo to give the crude product. This was washed with acetonitrile (3×20 mL), and the upper acetonitrile phases were discarded. After drying in vacuo, the product was obtained as a viscous liquid.

### Example 2 (EX-2)

PREPARATION OF HYPERBRANCHED POLYMER 4: 1,1,4,4-Tetramethyl-1,4-disilabutane (6.24 g, 0.0426 mol) was added dropwise to a solution of 1,2,4-trivinylcyclohexane (9.69 g, 0.0597 mol, 2.1 molar excess of vinyl) and platinum divinyltetramethyldisiloxane complex (1 drop, 3 wt. % Pt in vinyl-terminated PDMS) in toluene (30 mL). After an initial exotherm, the reaction mixture was stirred at 60° C. for 3 days, and toluene was removed in vacuo to give the crude product. This was washed with acetonitrile (3×20 mL), and the upper acetonitrile phases were discarded. After drying in vacuo, the product was obtained as a waxy solid (melting point <80° C.).

### Comparative Example C (CE-C)

PREPARATION OF HYPERBRANCHED POLYMER 5: 1,1,3,3-Tetramethyldisiloxane (5.90 g, 0.0440 mol) was added dropwise to a solution of tetravinylsilane (9.29 g, 0.0681 mol, 3.1 molar excess of vinyl) and platinum divinyltetramethyldisiloxane complex (1 drop, 3 wt. % Pt in vinyl-terminated PDMS) in toluene (60 mL). After an initial exotherm, the reaction mixture was stirred at room temperature for 2 days, and toluene and excess monomer was removed in vacuo to give the product as a viscous liquid.

### Example 3 (EX-3)

PREPARATION OF HYPERBRANCHED POLYMER 6: 1,1,3,3-Tetramethyldisiloxane (6.60 g, 0.0491 mol) was added dropwise to a solution of 1,2,4-trivinylcyclohexane (11.2 g, 0.0688 mol, 2.1 molar excess of vinyl) and platinum divinyltetramethyldisiloxane complex (1 drop, 3 wt. % Pt in vinyl-terminated PDMS) in toluene (80 mL). After an initial exotherm, the reaction mixture was stirred at room temperature for 2 days, and toluene was removed in vacuo to give the crude product. This was washed with acetonitrile (3×20 mL), and the upper acetonitrile phases were discarded. After drying in vacuo, the product was obtained as a viscous liquid.

Table 2, below, reports dielectric constants, dissipation factors, glass transition temperatures, and TGA data (5% weight loss temperature in air) for hyperbranched polymers (i.e., reaction products) 1 to 6.

TABLE 2

| | DIELECTRIC | | | TGA, | TGA, |
|---|---|---|---|---|---|
| | CONSTANT, | TAN δ, | | ° C. 5% | ° C. 5% |
| | 20° C. at | 20° C. at | T_{g}, | loss/air | loss/air |
| EXAMPLE | 2.45 GHz | 2.45 GHz | ° C. | Pre-cure | Post-cure |
| CE-A | 2.29 | 0.002 | −74 | 254 | NA |
| EX-1 | 2.44 | 0.004 | −11 | 232 | NA |
| CE-B | 2.43 | 0.010 | −94 | 216 | 257 |
| EX-2 | 2.36 | 0.004 | −52 | 231 | 272 |
| CE-C | 2.47 | 0.008 | −91 | 119 | 245 |
| EX-3 | 2.36 | 0.005 | −66 | 218 | 253 |

### Thermal Cure

CE-B, EX-2, CE-C, and EX-3, were thermally cured by adding dicumyl peroxide at 2 wt. %, depositing 0.25 mL of formulation onto a glass microscope slide via pipette, and heating at 150° ° C. for 120 minutes.

The preceding description, given in order to enable one of ordinary skill in the art to practice the claimed disclosure, is not to be construed as limiting the scope of the disclosure, which is defined by the claims and all equivalents thereto.

1. A reaction product of components comprising:
an alicyclic hydrocarbon containing at least one 5- or 6-membered ring and having at least two carbon-carbon multiple bonds; and
a first organosilane represented by the formula 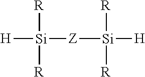
wherein each R independently represents an aliphatic hydrocarbyl group having from 1 to 8 carbon atoms, and Z represents —(CH₂)_{y}—, wherein y is an integer from 1 to 18.

2. (canceled)

3. (canceled)

4. The reaction product of claim 1, wherein the 5- or 6-membered ring is bonded to from 2 to 4 monovalent groups having the formula —(CH₂)ₓCH═CH₂, wherein each x is independently 0 or 1.

5. The reaction product of claim 1, wherein at least one of the at least two carbon-carbon multiple bonds is contained within the at least one 5- or 6-membered ring.

6. The reaction product of claim 1, wherein the reaction product is hyperbranched and comprises a plurality of vinyl groups.

7. A two-part curable composition comprising:
a Part A comprising:
a reaction product according to claim 6, and
a hydrosilylation catalyst; and
a Part B comprising a second organosilane represented by the formula 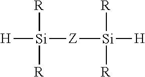
wherein each R independently represents an aliphatic hydrocarbyl group having from 1 to 8 carbon atoms, and Z represents —(CH₂)_{y}— or —(OSiR₂)_{y}—, wherein y is an integer from 1 to 18.

8. The two-part curable composition of claim 7, wherein the hydrosilylation catalyst comprises platinum or rhodium.

9. A curable composition comprising:
a reaction product according to claim 6, and
a free-radical initiator.

10. The curable composition of claim 9, wherein the free-radical initiator comprises an organic peroxide.

11. A method of making a reaction product, the method comprising combining components comprising:
a) an alicyclic hydrocarbon containing at least one 5- or 6-membered ring and having at least two carbon-carbon multiple bonds;
b) a first organosilane represented by the formula 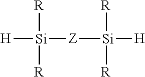
wherein each R independently represents an aliphatic hydrocarbyl group having from 1 to 8 carbon atoms, and Z represents —(CH₂)_{y}—, wherein y is an integer from 1 to 18; and
c) a hydrosilylation catalyst.

12. The method of claim 11, wherein the hydrosilylation catalyst comprises platinum or rhodium.

13. (canceled)

14. (canceled)

15. The method of claim 11, wherein the 5- or 6-membered ring is bonded to from 2 to 4 monovalent groups having the formula —(CH₂)ₓCH═CH₂, wherein each x is independently 0 or 1.

16. The method of claim 11, wherein the reaction product is hyperbranched and comprises a plurality of vinyl groups.
